(19) United States
(12) Patent Application Publication
(10) Pub. No.: US 2024/0419375 A1
(43) Pub. Date: Dec. 19, 2024

(54) STORAGE MEDIUM, INFORMATION PROCESSING APPARATUS, AND INFORMATION PROCESSING METHOD

(71) Applicant: CANON KABUSHIKI KAISHA, Tokyo (JP)

(72) Inventor: YUKIYASU IWASAKI, Tokyo (JP)

(21) Appl. No.: 18/737,791

(22) Filed: Jun. 7, 2024

(30) Foreign Application Priority Data
Jun. 13, 2023 (JP) 2023-096715

(51) Int. Cl. G06F 3/12; G06F 8/71

(52) U.S. Cl. CPC G06F 3/123; G06F 3/1203; G06F 8/71

(57) ABSTRACT

A non-transitory computer-readable storage medium containing a program of a first application for causing a computer to execute a method to perform an execution process for executing a second application different from the first application, the second application is linked with the first application, and execute an update process for updating the first application in a case where a user instruction to cause a control unit to perform the execution process is input.

### BACKGROUND

### Field

The present invention relates to a storage medium, an information processing apparatus, and an information processing method.

### Description of the Related Art

Printer-specific software (hereinafter, “specific printer driver”) provided by printer vendors is known as software for controlling printers. Further, techniques for providing a standard printing function (hereinafter, referred to as “OS standard printing function”) by an operating system (hereinafter, referred to as “OS”) without necessitating a specific printer driver are also known. The OS standard printing function runs on a printing system (hereinafter, referred to as “OS printing system”) provided by the OS. As one of the printing systems, a Common UNIX® Printing System (CUPS®) configured to run on macOS® by Apple Inc. is known.

Further, printer control software that provides various functions, in the form of an application, such as a function of printing and displaying printer status information, a maintenance function execution function, and a printer setup function, separately from the printer driver and the OS standard printing function are also known. The printer status information herein refers to error information about errors that occur in a printer body and printer ink level information. Further, the maintenance function refers to a printhead cleaning function and a test printing function of checking for clogs in a printhead. Further, the printer setup function refers to a function of installing related applications to use a printer from an information processing apparatus such as a personal computer (PC), a printer operation preparation guide function, a network connection setting function, and a print queue registration function.

In order to use a printer control application, a target printer needs to be selected. For example, in order to execute printing using a desired printer, a user designates a printer to execute printing via a print settings screen. In order to designate a printer via the print settings screen, a printer queue that is printer information needs to be registered in advance in the PC. Further, in order to register the printer queue in the PC, the printer and the PC need to be connected to each other, and a communication path needs to be configured by setting the printer on the same network as the PC or establishing a universal serial bus (USB) connection. Since the foregoing settings are not configured for the printer immediately after purchase, there is a setup application that provides a setup function for establishing a communication path between the printer and the PC so that the printer can be used from the PC. The setup function mainly performs establishment of a communication path between the printer and the PC and registration of a printer queue in the PC. This makes it possible to use functions that use the printer, such as printing and scan functions, from the PC.

Further, there is a portal application that provides functions such as printing and scan functions that use the printer from the PC. Executing the setup application from the portal application makes it possible to perform a printer setup on the setup application from the portal application as a starting point. Thus, after performing the printer setup, the user can start using printer functions such as printing and scanning smoothly using the portal application.

Japanese Patent Application Laid-Open No. 2016-24505 discusses a technique for downloading a program for executing another application from a starting point (parent) application and executing the other application from the starting point application.

As described in the Description of the Related Art section, in a case where an application links with another application to perform operations, the applications transfer parameters to each other to perform linked operations based on statuses of the applications and execution results. In order to transfer parameters and perform linked operations, linking specifications of the applications need to match. For example, in a case where a version of the parent application is old, the linking specifications do not match, so that the parameters to be passed in executing the linked application of the latest version may become insufficient, or parameter specifications may become mismatched. In this case, the linked application may not operate as expected. Further, an unidentified parameter may be received from the linked application, or parameter specifications may become mismatched. In this case, the parent application may not operate as expected.

According to the invention discussed in Japanese Patent Application Laid-Open No. 2016-24505, in a case where an application links with another application to perform operations, a version of the parent application is updated to execute the linked application, so that the linked application can be executed in executing the parent application. However, the version update of the parent application is not intended to be performed in executing a function that links with a specific application to perform operations.

### SUMMARY

The present invention is directed to an application having a function of linking with another application, and proper operations of a parent application and a linked application.

According to an aspect of the present invention, a non-transitory computer-readable storage medium containing a program of a first application for causing a computer execute a method includes performing an execution process for executing a second application different from the first application, to the second application is linked with the first application, and executing an update process for updating the first application in a case where a user instruction to perform the execution process is input.

Further features of the present disclosure will become apparent from the following description of exemplary embodiments with reference to the attached drawings.

### BRIEF DESCRIPTION OF THE DRAWINGS

FIG. 1 is a diagram illustrating a hardware configuration of a printing system according to a first exemplary embodiment.

FIG. 2 is a diagram illustrating an overall configuration of the printing system according to the first exemplary embodiment.

FIG. 3 is a diagram illustrating a network configuration according to the first exemplary embodiment.

FIG. 4 is a diagram illustrating a display unit of a portal application according to the first exemplary embodiment.

FIG. 5 is a diagram illustrating application information according to the first exemplary embodiment.

FIG. 6 is a diagram illustrating client information according to the first exemplary embodiment.

FIG. 7 is a flowchart illustrating an application linking process according to the first exemplary embodiment.

FIGS. 8A and 8B are diagrams illustrating screens displayed by a portal application according to a second exemplary embodiment.

FIG. 9 is a flowchart illustrating an application linking process according to the second exemplary embodiment.

FIGS. 10A and 10B are diagrams illustrating screens displayed by portal applications according to third and fifth exemplary embodiments.

FIGS. 11A and 11B are diagrams illustrating a linking processing failure screen and a linking processing success screen according to a seventh exemplary embodiment.

FIG. 12 is a diagram illustrating a linked option selection screen according to the seventh exemplary embodiment.

### DESCRIPTION OF THE EMBODIMENTS

Various exemplary embodiments of the present disclosure will be described below with reference to the attached drawings. The following exemplary embodiments are not intended to limit the disclosure, and not all combinations of features according to the exemplary embodiments are always essential to a technical solution provided by the present disclosure.

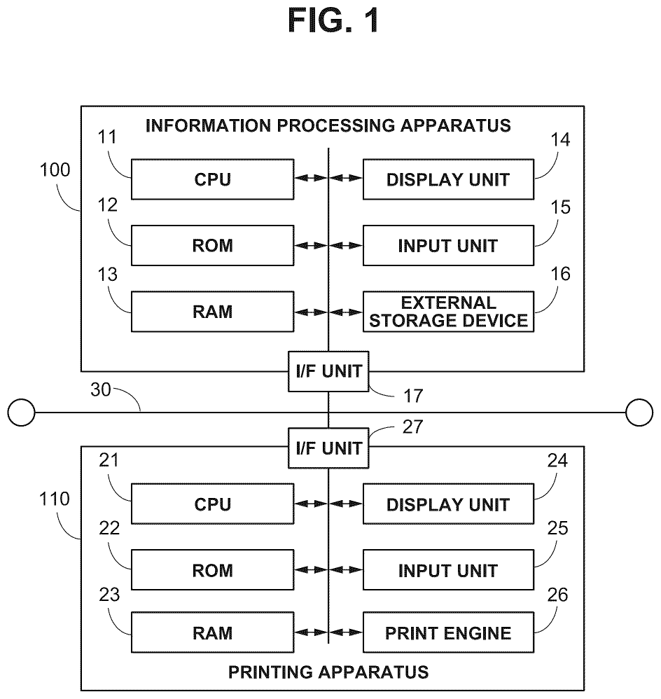

First, an overall configuration of a printing system according to a first exemplary embodiment will be described below with reference to FIG. 1. FIG. 1 is a block diagram illustrating a hardware configuration of the printing system according to the present exemplary embodiment. According to the present exemplary embodiment, an information processing apparatus 100, serving as a host computer, and a printing apparatus 110 are connected to each other via a communication bus 30 (network) such as a local area network (LAN). While only one printing apparatus (printer) is illustrated in FIG. 1, any number of printers can be connected via the communication bus 30.

The information processing apparatus 100 is an example of an information processing apparatus. An operating system (hereinafter, referred to as “OS”) is installed in the information processing apparatus 100. An information processing apparatus 120 described below has a similar configuration. The information processing apparatus 100 is, for example, a personal computer (PC) and includes an interface (I/F) unit 17, a central processing unit (CPU) 11, a read-only memory (ROM) 12, a random access memory (RAM) 13, a display unit 14, an input unit 15, and an external storage device 16. The information processing apparatus 100 according to the present exemplary embodiment is not limited to a desktop PC and may be a laptop PC, a tablet PC, or a mobile terminal such as a smartphone.

The CPU 11 is a central processing unit that controls components of the information processing apparatus 100 and executes control programs such as the OS. System operations are controlled by the OS stored in the ROM 12. The RAM 13 is a random access memory to which a workspace of the CPU 11 is deployed. The external storage device 16 stores various control programs such as applications. The input unit 15 is an input device such as a keyboard and a mouse for operating the information processing apparatus 100. The display unit 14 is a display device that displays information input from the input unit 15 for confirmation, user interface screens of the OS, user interface screens of the applications, and messages. The I/F unit 17 is a communication module that transmits and receives data to and from the printing apparatus 110.

The printing apparatus 110 is, for example, an inkjet printer. The printing apparatus 110 includes an I/F unit 27, a CPU 21, a ROM 22, a RAM 23, a display unit 24, an input unit 25, and a print engine 26. The CPU 21 is a central processing unit that controls the following components. The ROM 22 is a read-only memory and stores programs for controlling the print engine 26. The RAM 23 is a random access memory and temporarily stores necessary programs for operations of the print engine 26 and setting values received from the information processing apparatus 100. The input unit 25 is a button for operating the printing apparatus 110. The display unit 24 is a display device that displays information input from the input unit 25 for confirmation or status messages about the printing apparatus 110.

The print engine 26 prints on recording media based on print data transmitted from the information processing apparatus 100. The I/F unit 27 is a communication module that receives print data from the information processing apparatus 100 and has a function of transmitting current status information about the printing apparatus 110 from the printing apparatus 110 to the information processing apparatus 100. The status information herein refers to status data that indicates a status of the printing apparatus 110 and can be returned from the printing apparatus 110 in response to a request from the information processing apparatus 100 connected via the I/F unit 27. The status data refers to information for notifying an operational status of the printing apparatus 110, such as “printing” or “standby state”, or an error status of the printing apparatus 110, such as “out of sheet”, “cover is open”, or “out of ink”.

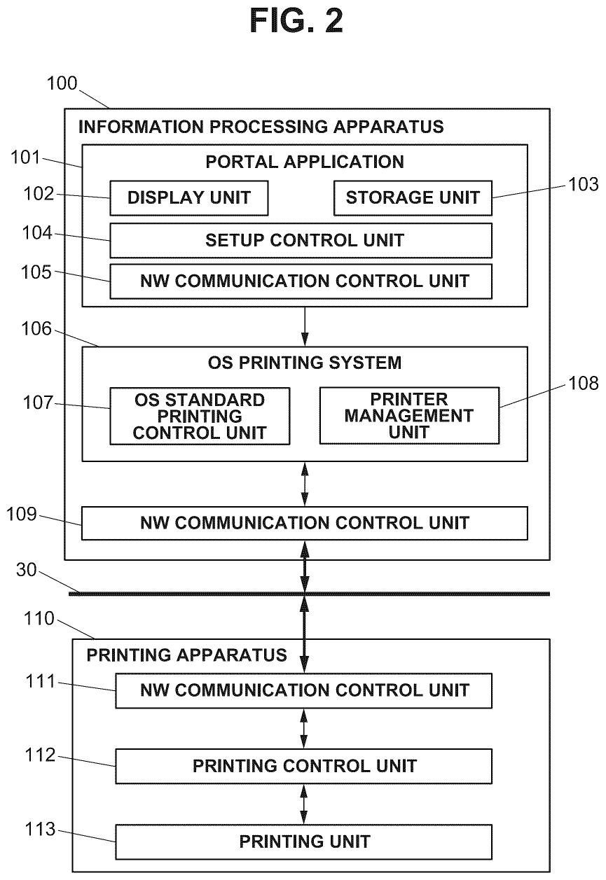

FIG. 2 is a diagram illustrating an overall configuration of a printing system according to the present exemplary embodiment. First, a software configuration of the information processing apparatus 100 will be described below. The information processing apparatus 120 described below has a similar configuration. The information processing apparatus 100 includes a portal application 101, an OS printing system 106, and a network (NW) communication control unit 109. The portal application 101 includes a display unit 102, a storage unit 103, a setup control unit 104, and a NW communication control unit 105. Further, the OS printing system 106 includes an OS standard printing control unit 107 and a printer management unit 108. The portal application 101 is software for using a printing apparatus from an information processing apparatus and is installed in the information processing apparatus 100 as needed. The portal application 101 is software running on the OS, which is basic software of the information processing apparatus 100. The portal application 101 provides various functions such as a printing function, a function of displaying printer status information, a function of executing a maintenance function, and a printer setup function. The printing by the portal application 101 is realized by designating a file in a predetermined format (standard format) selected by a user to the OS printing system 106.

The OS printing system 106 is an element of the OS that performs printing control and sequentially processes print requests from the portal application 101 as jobs. The OS standard printing control unit 107 of the OS printing system 106 is software with a necessary standard function (OS standard printing function) for generating print data. The OS standard printing control unit 107 spools drawing data generated by the portal application 101 and generates print data in the predetermined format. Furthermore, in order to transmit the generated print data in the standard format to the printing apparatus 110, the OS standard printing control unit 107 performs processing of outputting the print data in the standard format to the NW communication control unit 109. The OS standard printing control unit 107 according to the present exemplary embodiment communicates with the printing apparatus 110 via the NW communication control unit 109 using the Internet Printing Protocol (IPP), which is a standard printing protocol. Further, the OS standard printing control unit 107 acquires capability information about the printing apparatus 110 via the NW communication control unit 109 to determine whether the printing apparatus 110 supports the OS standard printing function.

A flow of issuing a print instruction will be described below. After generating drawing data, the portal application 101 issues a print request to the OS printing system 106 based on a user instruction. The print request is input as a print job to the OS printing system 106. In a case where a print request is issued, an instruction to set print settings from the user can be received via a setting screen provided by the OS standard printing control unit 107.

In a case where a print request is issued, a print job including information about the print settings and the drawing data generated by the portal application 101 is transmitted from the portal application 101 to the OS printing system 106. The information about the print settings includes sheet size information, sheet feeding method information, and information indicating which print queue to use for printing.

In a case where the OS standard printing control unit 107 of the OS printing system 106 receives a print job, the OS standard printing control unit 107 generates print data in the predetermined format based on the OS standard printing function. The printing apparatus 110 compatible with the OS standard printing function can interpret print data in a format based on the OS standard printing function. Then, the OS printing system 106 transmits the generated print data to the printing apparatus 110 compatible with the OS standard printing via the NW communication control unit 109. The printing apparatus 110 includes a NW communication control unit 111, a printing control unit 112, and a printing unit 113. The printing control unit 112 receives print data from the information processing apparatus 100 via the NW communication control unit 111 and controls the printing unit 113 to perform printing based on the print data. Similarly, a printing apparatus 130 described below includes a NW communication control unit, a printing control unit, and a printing unit.

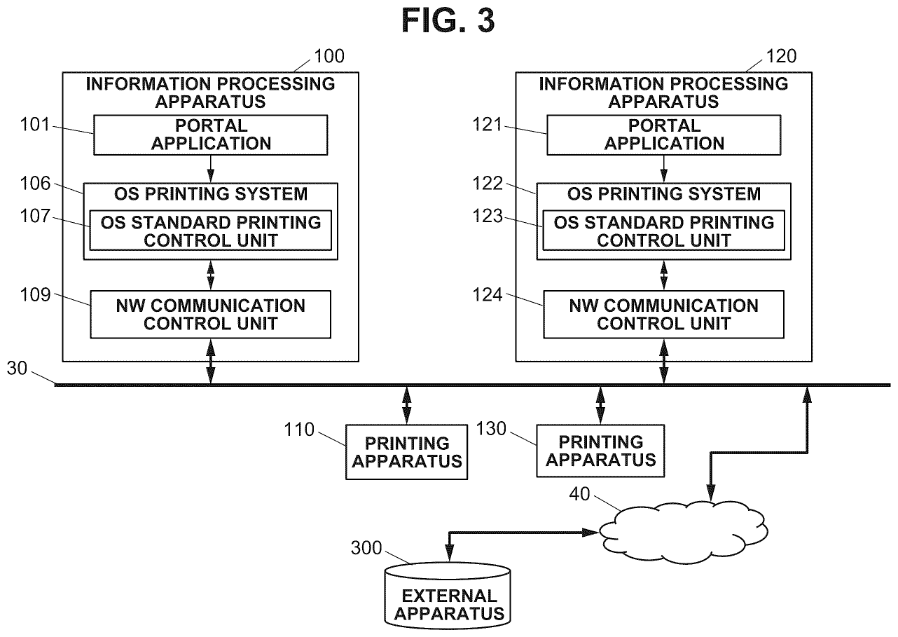

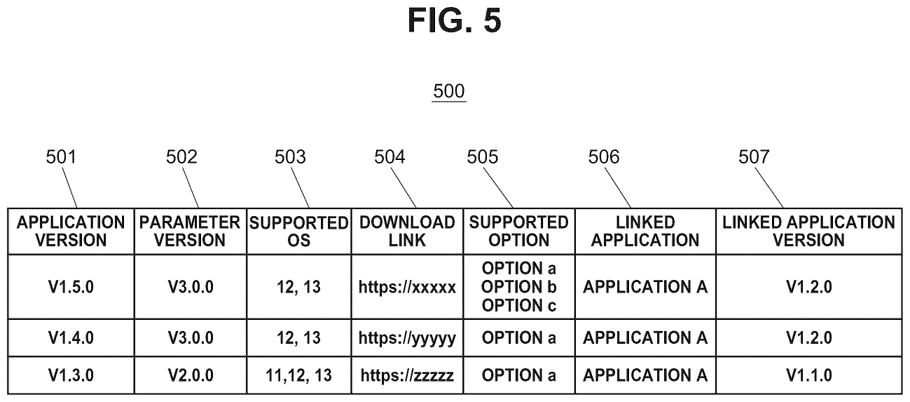

Next, a network configuration according to the present exemplary embodiment will be described below with reference to FIG. 3. Two PCs that are the information processing apparatuses 100 and 120 are connected to an internet 40 via a network 30. Similarly, the printing apparatus 110 is connected to the internet 40 via the network 30 such as a LAN. Similarly, an external apparatus 300 is connected to the internet 40. The external apparatus 300 stores information related to the portal application 101 as illustrated in FIG. 5. In FIG. 3, the printing apparatus 130 is a printer immediately after purchase, and no network settings are configured for the printing apparatus 130. The network settings refer to, for example, settings for connecting the printer and a wireless LAN (Wi-Fi) router to each other.

In order to use the printing apparatus 130 from the information processing apparatus 100, the user executes the setup function of the portal application 101 of the information processing apparatus 100 and performs a setup including the network settings of the printing apparatus 130. The setup includes not only the network settings of the printing apparatus 130 but also initial settings such as ink installation and registration alignment for enabling the printing apparatus 130 for use and print queue registration and related application installation for using the printing apparatus 130 from the information processing apparatus 100.

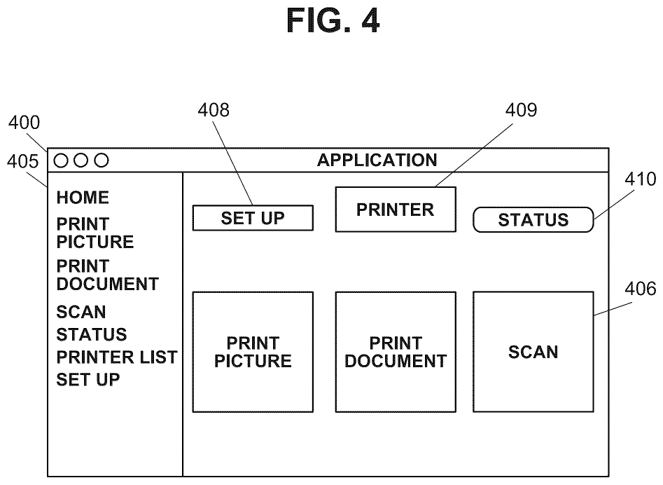

FIG. 4 is a diagram illustrating an example of a display screen of the portal application 101 according to the present exemplary embodiment. During execution of the portal application 101, an application window 400 is displayed on the display unit 14 of the information processing apparatus 100. Functions of the portal application 101 can be executed by selecting a scan button 406 or an application menu 405 from the application window 400. Further, a list of printers supported by the portal application 101 among printers registered in the printer management unit 108 can be checked by pressing a printer list button 407.

Further, a printer icon 409 indicates a printer being used by the portal application 101, and a status of the printer being used by the portal application 101 can be checked by pressing a status button 410.

At the press of a set up button 408, the setup control unit 104 executes the printer setup function, which is one of linked functions. In a case where the setup function of the portal application 101 is executed, the setup control unit 104 of the portal application 101 downloads a setup application from the internet 40 and activates the downloaded setup application. The user sets up the printing apparatus 130 using the setup application and ends the setup application, whereby the printing apparatus 130 becomes available for use from the information processing apparatus 100 and the portal application 101. The setup application configures the initial settings such as the network settings of the printing apparatus 130, ink installation and registration alignment for enabling the printing apparatus 130 for use, and print queue registration and related application installation for using the printing apparatus 130 from the information processing apparatus 100.

FIG. 5 illustrates application information that the setup control unit 104 acquires from the external apparatus 300 in a case where the setup function of the portal application 101 is executed according to the present exemplary embodiment. Application information 500 is information about the portal application 101 and includes an application version 501, a parameter version 502, a supported OS 503, and a download link 504. Furthermore, a supported option 505, a linked application 506, and a linked application version 507 are included.

The application version 501 specifies available application versions of the portal application 101. The parameter version 502 defines versions of parameter specifications in a case where the application versions link with a linked application described below. For example, in a case where there is a change in parameter specifications or a parameter is added, the parameter version is upgraded for management to manage the parameter specifications uniquely based on the parameter version. In a case where there is a plurality of linked applications, a parameter version may be stored in association with each linked application. The supported OS 503 specifies OS versions supported by the application versions. The download link 504 specifies universal resource locators (URLs) for downloading the application versions, and the portal application 101 of a target application version can be downloaded by accessing an URL for the target application version.

The supported option 505 specifies functions supported by the application versions. For example, the application information 500 in FIG. 5 specifies that only an application version v1.5.0 supports functions of options b and c. The linked application 506 specifies applications with which the application versions are to be linked. The linked application version 507 specifies application versions of the linked application 506 that are supported in linking with the linked application 506 to perform operations. For example, the application information 500 specifies that the application versions v1.5.0and v1.4.0 support a linked application version v1.2.0. Further, an application version v1.3.0 is specified as supporting a linked application version v1.1.0. The setup control unit 104 refers to the application version 501 from the acquired application information 500 and determines the latest application version. In the example of the application information 500 in FIG. 5, the latest application version is v1.5.0.

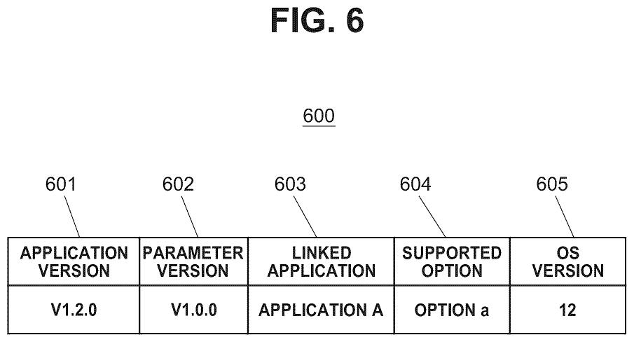

FIG. 6 illustrates client information to which the setup control unit 104 of the portal application 101 refers according to the present exemplary embodiment. Client information 600 is stored in the RAM 13 of the information processing apparatus 100 and is information about the information processing apparatus 100 and the portal application 101 installed in the information processing apparatus 100. The client information 600 includes an application version 601, a parameter version 602, a linked application 603, a supported option 604, and an OS version 605.

The application version 601 specifies an application version of the portal application 101 installed in the information processing apparatus 100 and is acquired from the storage unit 103 of the application 101. Similarly, the parameter version 602 specifies a parameter version of the portal application 101 and is acquired from the storage unit 103 of the application 101. The linked application 603 specifies an application with which the application 101 links, and is acquired similarly from the storage unit 103 of the application 101. The supported option 604 specifies an option that can be designated in a case where the user issues an input instruction to the portal application 101. For example, in a case where a setup target printer designation option is supported as an option a, a setup target printer name can be designated to the linked application. The OS version 605 specifies an OS version of the information processing apparatus 100 and is acquired from the OS by the setup control unit 104.

The setup control unit 104 compares the latest application version acquired from the external apparatus 300 with the application version of the portal application 101.

In a case where a newer version of the portal application than the application version of the portal application 101 is disclosed by the external apparatus 300, the setup control unit 104 performs an application download from the download link 504. The portal application 101 installed in the information processing apparatus 100 is replaced with the downloaded portal application 101 of the latest version to make it possible to perform linking processing with the linked application with the latest integration specifications.

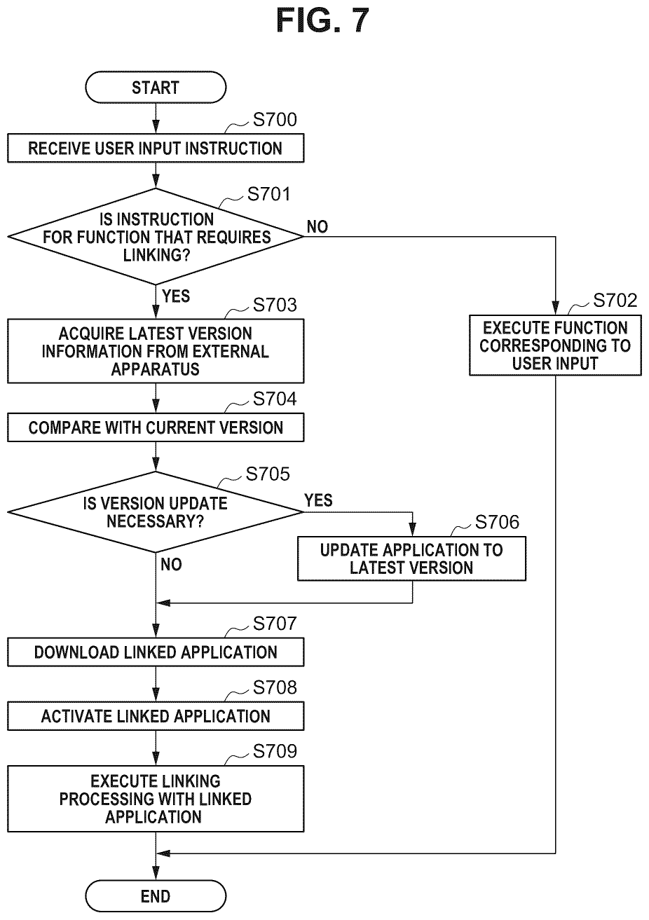

FIG. 7 is a flowchart illustrating a process that the setup control unit 104 of the portal application 101 performs to use the printing apparatus 130 from the information processing apparatus 100. While the setup control unit 104 will be described below as performing each operation, in reality, the CPU 11 executes corresponding programs to thereby realize corresponding functions. A process flow in FIG. 7 is started in a case where an instruction is input to the portal application 101 by the user.

In step S700, the portal application 101 acquires an input instruction selected by the user, and the processing proceeds to step S701. In step S701, whether the user input instruction is an instruction for a function that requires linking with an external application is determined. Whether a function requires linking with an external application may be defined in advance in the portal application 101 and determined or may be acquired dynamically from the external apparatus 300 and determined. In the description herein, each function that is executed at the press of the set up button 408 is defined in advance as a function that requires linking with an external application in the portal application 101.

In a case where the determination result in step S701 indicates that the instruction is not for a function that requires linking with an external application (NO in step S701), the processing proceeds to step S702. In a case where the set up button 408 is selected as a user input instruction, the instruction is determined as an instruction for a function that requires linking with an external application (YES in step S701), and the processing proceeds to step S703. In step S702, a function corresponding to the user input is executed, and the process is ended.

In step S703, the latest version of the portal application 101 is acquired from the application information 500 acquired from the external apparatus 300, and the processing proceeds to step S704. Only the latest version of the portal application 101 in the application information 500 may be acquired from the external apparatus 300. In step S704, the latest version acquired in step S703 and the current version of the portal application 101 that is acquired from the client information 600 are compared, and the processing proceeds to step S705. In step S705, in a case where the versions do not match as a result of step S704, it is determined that a version update is necessary (YES in step S705), and the processing proceeds to step S706, whereas in a case where the versions match, it is determined that a version update is unnecessary (NO in step S705), and the processing proceeds to step S707. In step S706, the portal application 101 of the information processing apparatus 100 is updated to the latest version, and the processing proceeds to step S707. The version of the portal application 101 may be updated by replacing the portal application 101 with the latest version of the portal application 101 downloaded to the information processing apparatus 100 by acquiring a download link from the external apparatus 300 and accessing the link. Further, the download link acquisition does not have to be from the external apparatus 300 and, for example, the storage unit 103 of the portal application 101 may store a download link for downloading the latest version.

In step S707, the linked application is downloaded to the information processing apparatus 100, and the processing proceeds to step S708. A download link for downloading the linked application may be stored in the application information 500 or may be stored in the external apparatus 300 separately from the application information 500. Further, the linked application may be downloaded to the information processing apparatus 100 by acquiring the download link of the linked application from the storage unit 103 of the portal application 101 and accessing the link. In step S708, the downloaded linked application is activated, and the processing proceeds to step S709. In step S709, the linking processing with the linked application is executed, and the process is ended.

The linking processing with the linked application refers to transmitting information about the portal application 101 as parameters to the linked application and causing the application 101 to operate based on parameters received from the linked application. For example, a name of the portal application 101 may be transmitted to the linked application so that the linked application recognizes that the linked application is activated from the portal application 101. This makes it possible to change the process from the process in a case where the user directly activates the linked application, and it also becomes possible to perform a process of transmitting parameters from the linked application to the portal application 101. Alternatively, the application version of the portal application 101 may be transmitted to the linked application so that the linked application can change the process based on the application version of the portal application 101.

Furthermore, the portal application 101 may receive parameters of processing results from the linked application so that the portal application 101 can display guidance to the user based on whether the processing has succeeded or failed. Thus, performing the linking processing with the linked application makes it possible to display the results of executing the function corresponding to the user input instruction using the linked application on the portal application 101 and complete the function. The parameter transmission to the linked application may be performed before, simultaneously with, or after activation of the linked application. Further, the parameter reception from the linked application may be performed during activation of the linked application or simultaneously with or after an end of the activation, and methods for the parameter transmission and reception are not limited to the designation of options during the activation of the portal application 101, and the parameter transmission and reception may be performed by outputting to a temporary file and reading from the temporary file.

The present exemplary embodiment makes it possible to perform a printer setup using the linked application after updating the version of the portal application 101 in a case where the portal application 101 is not the latest version. This makes it possible for the applications to operate with the linking specifications that are matched between the applications, so that the portal application 101 and the linked application operate as expected.

Further, a desired result can be expected from the function for which the user input instruction is issued. Further, since the process of downloading the linked application is performed after the version update of the portal application 101, it is always possible to link with the linked application of the latest version, so that a result desired by the user can be expected similarly.

Furthermore, according to the present exemplary embodiment, whether the user input instruction is for a function that requires linking is determined, and in a case where linking is required, the version of the portal application 101 is updated. On the other hand, in a case where the function executed by the user does not necessitate a version update of the portal application 101, the portal application 101 can be used without a version update, so that the processing time associated with the version update is saved.

Next, a second exemplary embodiment of the present disclosure will be described below. According to the first exemplary embodiment, in a case where a version update is necessary, the setup control unit 104 executes the process of updating the version of the portal application 101. According to the present exemplary embodiment, in a case where a version update is necessary, the setup control unit 104 performs a process of informing the user that a version update is necessary. Hereinafter, each component corresponding to a component according to the first exemplary embodiment is assigned the same reference numeral as the corresponding component, and redundant descriptions thereof are omitted. Mainly an update confirmation screen and an update instruction screen that the setup control unit 104 displays and a process flow of the setup control unit 104 will be described below as differences from the first exemplary embodiment.

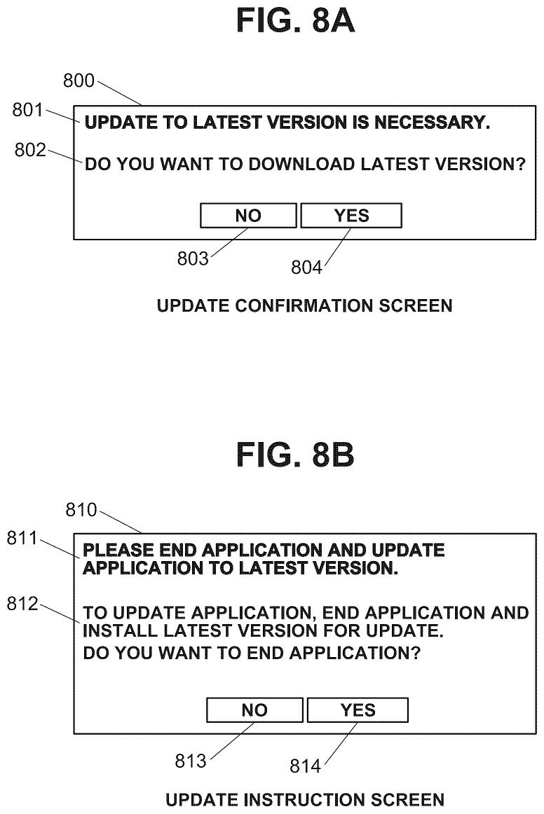

FIGS. 8A and 8B are diagrams illustrating an update confirmation screen and an update instruction screen that the portal application 101 displays according to the present exemplary embodiment. FIG. 8A illustrates the update confirmation screen, and FIG. 8B illustrates the update instruction screen. An update confirmation screen 800 in FIG. 8A informs the user that an update of the portal application 101 to the latest version is necessary. The update confirmation screen 800 includes an update informing message 801 informing the user that an update to the latest version is necessary, a download confirmation message 802, a download cancellation button 803, and a download execution button 804. The update confirmation screen 800 is displayed on the display unit 102 in a case where the user executes a function that performs linking with an external application and the setup control unit 104 determines that a version update of the portal application 101 is necessary. At the press of the download cancellation button 803 by the user, execution of the function that performs linking is ended without executing a download of the latest version. At the press of the download execution button 804 by the user, a download of the latest version of the portal application 101 is executed.

FIG. 8B is a diagram illustrating an update instruction screen for prompting the user to end the portal application 101 and update the portal application 101 to the latest version. An update instruction screen 810 includes an update instruction message 811 instructing the user to end the portal application 101 and update the portal application 101 to the latest version, an end confirmation message 812, an end cancellation button 813, and an end button 814. The update instruction screen 810 is displayed on the display unit 102 after the setup control unit 104 completes the process of downloading the portal application 101 of the latest version. At the press of the end cancellation button 813 by the user, the function that performs linking processing is ended. At the press of the end button 814 by the user, the portal application 101 is ended.

The update confirmation screen 800 and the update instruction screen 810 may be displayed on the display unit 102 by the setup control unit 104 or may be notified to the OS by the setup control unit 104 so that the OS displays the update confirmation screen 800 and the update instruction screen 810 on an OS notification area.

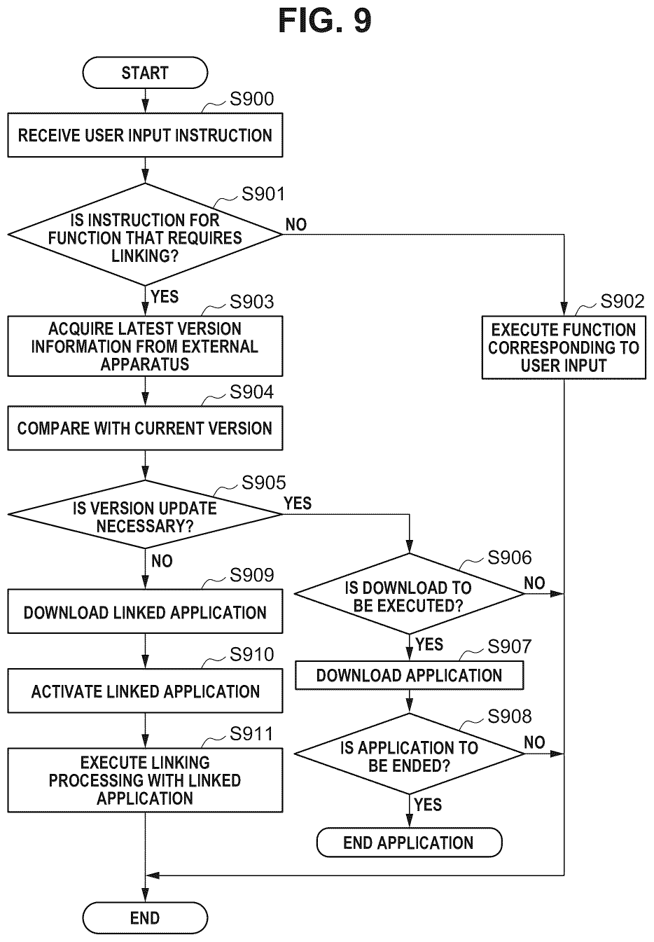

FIG. 9 is a flowchart illustrating a process that the setup control unit 104 of the portal application 101 performs to use the printing apparatus 130 from the information processing apparatus 100 according to the present exemplary embodiment. More specifically, a process flow in which the setup control unit 104 of the portal application 101 confirms a version update of the portal application 101 with the user is illustrated. While the setup control unit 104 will be described below as performing each operation, in reality, the CPU 11 executes corresponding programs to thereby realize corresponding functions. The process flow in FIG. 9 is started in a case where an instruction is input to the portal application 101 by the user.

Steps S900 to S905 and S909 to S911 in FIG. 9 correspond to steps S700 to S705 and S707 to S709 in FIG. 7 according to the first exemplary embodiment, so that redundant descriptions thereof are omitted.

According to the present exemplary embodiment, the processing proceeds to step S906 in a case where it is determined that a version update of the portal application 101 is necessary in step S905 in FIG. 9.

In step S906, whether the user has selected to execute a download on the update confirmation screen 800 displayed on the display unit 102 by the portal application 101 is determined. In a case where the download cancellation button 803 is pressed by the user (NO in step S906), the process is ended. In a case where the download execution button 804 is pressed by the user (YES in step S906), the processing proceeds to step S907.

In step S907, the setup control unit 104 downloads the latest version of the portal application 101 to the information processing apparatus 100, and the processing proceeds to step S908. The latest application may be downloaded by acquiring a download link from the external apparatus 300 and accessing the link or by accessing the download link of the latest version that is stored in the storage unit 103 of the application 101. In step S908, the update instruction screen 810 is displayed on the display unit 102 of the portal application 101, and in a case where the end cancellation button 813 is pressed by the user (NO in step S908), the process is ended. In a case where the end button 814 is pressed by the user (YES in step S908), the portal application 101 is ended, and the process is ended. After the portal application 101 is ended, the user performs an update to the latest version based on an instruction on the update instruction screen 810. After the update is completed, in a case where the user re-activates the portal application 101 and uses a linked function, it is determined that a version update is unnecessary in step S905 (NO in step S905), and the processing proceeds to step S909 to complete the process.

At some point between step S906 and the end of the portal application 101, information indicating that the user selects an update may be stored in the storage unit 103.

Then, the information and the application version that are stored in the storage unit 103 may be referred to at a time of activating the portal application 101, and a download of the linked application in subsequent step S909 may be started.

The present exemplary embodiment makes it possible to perform a printer setup using the linked application after updating the version of the portal application 101 in a case where the portal application 101 is not the latest version, as in the first exemplary embodiment. This makes it possible for the portal application 101 and the linked application to operate with the linking specifications that are matched, so that the portal application 101 and the linked application operate as expected, and a desired result can be expected with respect to the function for which the user input instruction is issued.

Further, the present exemplary embodiment prompts the user to select whether to perform an update in a case where a version update of the portal application 101 is necessary. This makes it possible to postpone using a function that necessitates an update in a case where the user wishes to use another function that does not necessitate an update, making it possible to enhance user convenience.

Furthermore, even in a case where the setup control unit 104 cannot replace the portal application 101 with the latest version, a version update of the portal application 101 can be performed by a user operation according to the present exemplary embodiment.

Next, a third exemplary embodiment of the present disclosure will be described below. According to the first and second exemplary embodiments, the setup control unit 104 executes the process for performing an update in a case where the portal application 101 is not the latest version. The third exemplary embodiment differs from the first and second exemplary embodiments in details of the process by which the setup control unit 104 determines whether an update of the portal application 101 is necessary. Hereinafter, each component corresponding to a component according to the first or second exemplary embodiment is assigned the same reference numeral as the corresponding component, and redundant descriptions thereof are omitted. Mainly the method by which the setup control unit 104 determines whether a version update of the portal application 101 is necessary will be described below as the difference from the first and second exemplary embodiments.

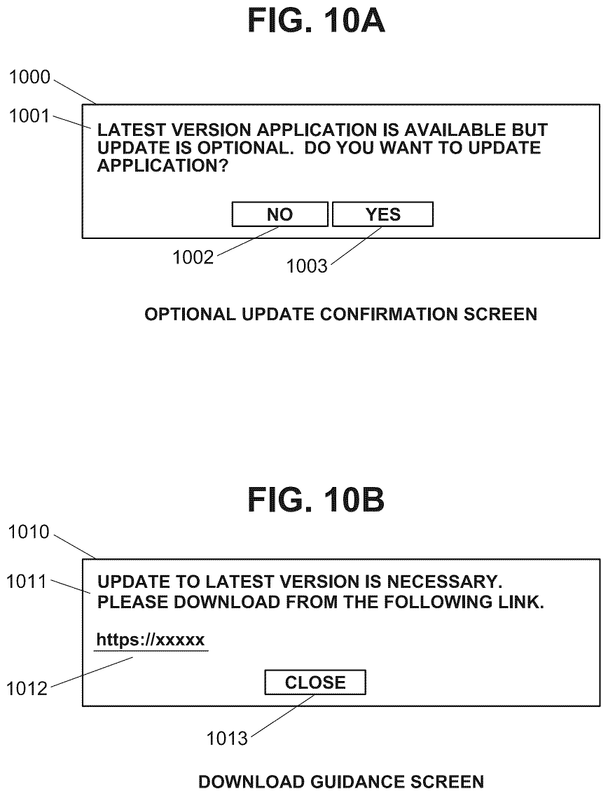

FIG. 10A is a diagram illustrating an optional update confirmation screen informing the user that an update of the portal application 101 to the latest version is optional. An optional update confirmation screen 1000 in FIG. 10A includes an optional update informing message 1001 informing the user that an update to the latest version is optional, an optional update cancellation button 1002, and an optional update execution button 1003.

The optional update confirmation screen 1000 is displayed in a case where the latest version of the portal application 101 is available and an update is optional at issuance of an instruction to execute the function of linking with an external application by the user. At the press of the optional update cancellation button 1002 by the user, the function of performing linking processing is continued without executing an update to the latest version. On the other hand, at the press of the optional update execution button 1003 by the user, the portal application 101 executes an update to the latest version.

According to the present exemplary embodiment, in a case where the linking specifications of the application 101 and the linked application match in the determination of whether an update of the application 101 is necessary by the setup control unit 104, it is determined that an update is optional. The parameter version 502 of the application information 500 defines specifications of linking parameters of the application 101. Specifically, in a case where there is a change in the linking parameters, the parameter version 502 may be changed to manage the specifications of the linking parameters based on the parameter version 502.

In a case where the parameter versions of the currently used (installed) portal application 101 and the latest application version match, the linking parameters handled in the current portal application 101 are the latest.

Specifically, the processing with the linked application can be performed using the latest linking parameters without performing an update of the application 101 to the latest version. Thus, no update of the portal application 101 to the latest version is necessary, and it can be determined that an update is optional.

According to the present exemplary embodiment, in a case where the current portal application 101 is not the latest version but the specifications of the linking parameters match, the linked function can be used without performing an update of the portal application 101. Thus, the linked function can be used immediately, enhancing user convenience. In a case where the parameter versions of the linking parameters of the current portal application 101 and the latest version of the portal application 101 do not match, the process for performing an update of the portal application 101 may be executed as in the first and second exemplary embodiments.

Next, a fourth exemplary embodiment of the present disclosure will be described below. Each component corresponding to a component according to the exemplary embodiments described above is assigned the same reference numeral as the corresponding component, and redundant descriptions thereof are omitted. The present exemplary embodiment is applied to a case where for example, the information processing apparatus 100 cannot execute an update of the portal application 101 to the latest version.

For example, in a case where the OS version 605 of the information processing apparatus 100 is 11, since the supported OS 503 corresponding to the latest application version v1.5.0 in the application information 500 specifies 12 and 13, the OS version 605 of the information processing apparatus 100 is not included in the supported OS 503. Thus, an update to the latest application version v1.5.0 cannot be performed.

In this case, an update to the latest version v1.3.0 among the application versions that support the OS version 605 of the information processing apparatus 100 is executed. However, performing the linking processing with the linked application of the latest version using the portal application 101 that is not the latest may cause the specifications of the linking parameters to become mismatched.

Thus, according to the present exemplary embodiment, the setup control unit 104 refers to the linked application 506 and the linked application version 507 in the application information 500 and acquires the corresponding linked application version. Since the linked application version corresponding to the application version v1.3.0 is v1.1.0, the linked application of v1.1.0 is downloaded, and the linking processing is performed.

The present exemplary embodiment therefore makes it possible to use the linked application with the specifications of the linking parameters that match in a case where an information processing apparatus of an old OS version is used and an update of the portal application 101 to the latest version cannot be executed, a linked application with the specifications of linking parameter that match is used.

Next, a fifth exemplary embodiment of the present disclosure will be described below. Each component corresponding to a component according to the exemplary embodiments described above is assigned the same reference numeral as the corresponding component, and redundant descriptions thereof are omitted. According to the fifth exemplary embodiment, a process of presenting a download guidance screen to the user in relation to a portal application download is performed.

FIG. 10B is a diagram illustrating a download guidance screen presenting a download link of the portal application 101 of the latest version to the user according to the present exemplary embodiment. A download guidance screen 1010 includes a download guidance message 1011 prompting the user to download the portal application 101 of the latest version. Furthermore, a download link 1012 and a download guidance screen close button 1013 are included. The download guidance screen 1010 is displayed in a case where the setup control unit 104 determines that the latest version of the application 101 is available and an update is necessary at issuance of an instruction to execute the function of linking with an external application by the user. Alternatively, the download guidance screen 1010 may be displayed at the press of the download execution button 804 or the optional update execution button 1003 by the user.

The download link 1012 is acquired from the download link 504 of the portal application 101 of the latest version in the external apparatus 300. By pressing the download link 1012, the user can download the portal application 101 of the latest version to the information processing apparatus 100. The download link 1012 does not have to be in the form of a link that can be pressed, and may be in text form. At the press of the download guidance screen close button 1013 by the user, the download guidance screen 1010 is closed.

While a case where the download guidance screen 1010 is displayed on the display unit 102 of the portal application 101 is described herein, this is not a limiting case and, for example, a web browser may be opened to display an application download page. Further, an application store application that distributes applications may be opened to display an application download page. In a case where the external apparatus 300 cannot be accessed and the latest version determination cannot be performed, the download guidance screen 1010 or the web browser may be opened to display an application download page so that the application 101 of the latest version is acquired.

The present exemplary embodiment makes it possible for the user to download the application 101 of the latest version from the download guidance screen 1010 at any time convenient for the user. Further, the portal application 101 can be downloaded to an arbitrary area of the information processing apparatus 100 by a user operation, enhancing user convenience.

Next, a sixth exemplary embodiment of the present disclosure will be described below. Each component corresponding to a component according to the exemplary embodiments described above is assigned the same reference numeral as the corresponding component, and redundant descriptions thereof are omitted. According to the sixth exemplary embodiment, in a case where a downloaded portal application is present on the information processing apparatus 100, the process of executing a version update is performed using the downloaded portal application. Further, in a case where a downloaded linked application is present on the information processing apparatus 100, a process of activating the downloaded linked application is performed.

In step S706 or S907, in a case where the portal application 101 of the latest version has been download and the downloaded portal application 101 is present on the information processing apparatus 100, a version update may be executed using the downloaded portal application 101. For example, in a case where the version update in step S706 has failed, since the downloaded portal application 101 of the latest version is present on the information processing apparatus 100, no re-download is necessary in step S706 in a case where the process flow illustrated in FIG. 7 is executed again. Similarly, in a case where no version update of the portal application 101 of the latest version that is downloaded in step S907 has not been performed by the user, no re-download is necessary in step S907 in a case where the process flow illustrated in FIG. 9 is performed again.

Furthermore, in step S707 or S909, in a case where the linked application of the latest version has been downloaded and the downloaded linked application is present on the information processing apparatus 100, the downloaded linked application may be executed. For example, in a case where the process flow in FIG. 7 or 9 is performed continuously, since the downloaded linked application of the latest version is present on the information processing apparatus 100, no re-download is necessary in step S707 or S909.

The determination may be performed, as in the third exemplary embodiment, based on whether the application 101 and the linked application of download target versions are present on the information processing apparatus 100 instead of the portal application 101 and the linked application of the latest versions.

The present exemplary embodiment makes it possible to reduce the processing time related to the process of downloading the portal application 101 and the linked application.

Next, a seventh exemplary embodiment of the present disclosure will be described below. Each component corresponding to a component according to the exemplary embodiments described above is assigned the same reference numeral as the corresponding component, and redundant descriptions thereof are omitted. A process by which the portal application 101 links with the linked application using the linking parameters according to the seventh exemplary embodiment will be described below.

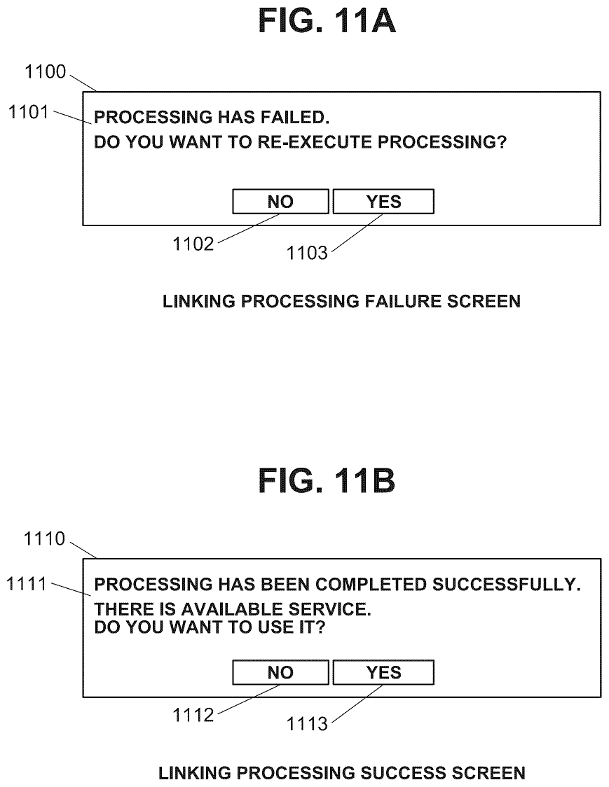

FIGS. 11A and 11B are diagrams illustrating screens that are displayed by the portal application 101 and present notifications of linking processing results according to the present exemplary embodiment. FIG. 11A is a diagram illustrating a linking processing failure screen informing the user that the linking processing has failed. A linking processing failure screen 1100 includes a linking processing failure message 1101 informing the user that the linking processing has failed and whether to re-execute the linking processing, a linking processing end button 1102, and a linking processing execution button 1103. The linking processing failure screen 1100 is displayed on the display unit 102 in a case where the portal application 101 receives a parameter indicating a failure of the processing of the linked application from the linked application. At the press of the linking processing end button 1102 by the user, the processing of the linked function is ended, whereas at the press of the linking processing execution button 1103 by the user, the linked function is re-executed.

FIG. 11B is a diagram illustrating a linking processing success screen informing the user that the linking processing has been completed successfully. A linking processing success screen 1110 includes a linking processing success message 1111 informing the user that the linking processing has been completed successfully, a linking processing end button 1112, and an additional function execution button 1113. The linking processing success message 1111 includes a message informing the user whether to execute a function that becomes executable on the portal application 101 after successful linking processing due to the successfully completed linking processing.

The linking processing success screen 1110 is displayed on the display unit 102 in a case where the portal application 101 receives a parameter indicating the successful completion of the processing of the linked application from the linked application. Furthermore, in a case where a detailed parameter due to the successful completion of the processing is received in addition to the parameter indicating the successful completion of the processing, the linking processing success message 1111 displays the details. For example, a printer is successfully set up by processing of the linked application, and parameters such as a name and serial number of the successfully setup printer are received from the linked application to use the information in the portal application 101. Based on the received printer name, available services may be presented on the portal application 101 or displayed on the printer icon 409 of the portal application 101 to enable the user to use the setup printer immediately and effectively. At the press of the linking processing end button 1112 by the user, the processing of the linked function is ended, whereas at the press of the additional function execution button 1113 by the user, a service function for the successfully setup printer is executed. Examples of the service function for the printer include registration in a membership service of the printer.

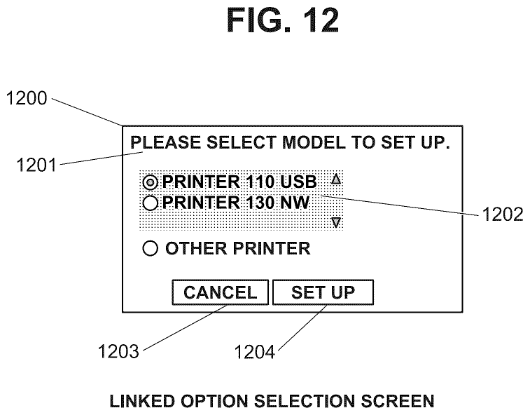

FIG. 12 is a diagram illustrating a linked option selection screen presented to the user in executing the linking processing according to the present exemplary embodiment. A linked option selection screen 1200 includes a setup printer selection message 1201 prompting the user to select a printer for which a setup is to be executed, a setup printer selection list 1202, a setup cancellation button 1203, and a setup execution button 1204. The linked option selection screen 1200 is displayed on the display unit 102 in activating the linked application in step S708 or S910. The setup printer selection list 1202 is a printer list from which the user selects a printer for which a setup is to be executed. In the example illustrated in FIG. 12, the setup printer selection list 1202 displays names of printers connected to the information processing apparatus 100 and forms of the connections. Not only the printers connected to the information processing apparatus 100 but all printers supported by the application 101 may be displayed, and the user may select a printer that the user wishes to set up.

At the press of the setup cancellation button 1203 by the user, the activation processing of the linked application is ended, whereas at the press of the setup execution button 1204 by the user, the name of the printer selected by the user is transmitted as a parameter to the linked application. This enables the linked application to perform setup processing for the printer that the user wishes to set up.

As described above, the present exemplary embodiment makes it possible for the portal application 101 to link with the linked application using the linking parameters.

### Other Exemplary Embodiments

It goes without saying that the present disclosure can be achieved also by providing a recording medium containing software program codes for realizing the functions according to the exemplary embodiments described above to a system or an apparatus and causing a computer (or a CPU or a micro-processing unit (MPU)) of the system or the apparatus to read the program codes stored in the recording medium and execute the read program codes. In this case, the program codes read from the storage medium realize the functions according to the exemplary embodiments described above, and the storage medium storing the program codes constitutes the present disclosure.

As a storage medium for providing the program codes, for example, a flexible disk, a hard disk, an optical disk, a magneto-optical disk, a compact disk (CD) ROM (CD-ROM), a CD recordable (CD-R), a magnetic tape, a non-volatile memory card, a ROM, or a digital versatile disk (DVD) can be used.

Further, it goes without saying that not only the cases where the functions of the exemplary embodiments described above are realized by executing the program codes read by the computer but also cases where part or all of the actual processing is performed by an OS running on the computer based on the instructions of the program codes and the processing realizes the functions of the exemplary embodiments described above are also encompassed.

Furthermore, it goes without saying that cases where the program codes read from the storage medium are written to a memory of a function expansion board added to the computer or a memory of a function expansion unit connected to the computer, part or all of the actual processing is performed by a CPU of the function expansion board or a CPU of the function expansion unit based on the instructions of the program codes, and the processing realizes the functions of the exemplary embodiments described above are also encompassed.

The exemplary embodiments can be combined freely, and optional components according to the exemplary embodiments can be modified or omitted within the scope of the present disclosure.

The present disclosure makes it possible for a parent application having a function of linking with another application and a linked application to operate properly.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-096715, filed June 13, 2023, which is hereby incorporated by reference herein in its entirety.

What is claimed is:

1. A non-transitory computer-readable storage medium containing a program of a first application for causing a computer to execute a method, the method comprising:
performing an execution process for executing a second application different from the first application, the second application is linked with the first application; and
executing an update process for updating the first application in a case where a user instruction to perform the execution process is input.

2. The non-transitory computer-readable storage medium according to claim 1, wherein the update process is a process of downloading the second application from an external apparatus and installing the second application into an information processing apparatus.

3. The non-transitory computer-readable storage medium according to claim 1, wherein the update process is a process of prompting a user to download the second application from an external apparatus and install the second application into an information processing apparatus.

4. The non-transitory computer-readable storage medium according to claim 1, wherein in a case where a version of the first application is not a latest version disclosed by an external apparatus, the update process for updating the first application to the latest version is executed.

5. The non-transitory computer-readable storage medium according to claim 4, wherein the computer is further caused to function as a determination unit configured to determine whether the version of the first application is the latest version disclosed by the external apparatus based on version information about the first application.

6. The non-transitory computer-readable storage medium according to claim 1, wherein the first application and the second application link with each other through transmission and reception of a parameter.

7. The non-transitory computer-readable storage medium according to claim 6, wherein the update process for updating the first application to the latest version is executed based on version information about the parameter in the first application and the second application.

8. The non-transitory computer-readable storage medium according to claim 1, wherein the update process for updating the first application to a latest version available for an update on an operating system (OS) of an information processing apparatus is executed.

9. The non-transitory computer-readable storage medium according to claim 1, wherein the execution process is a process of downloading a latest version of the second application from an external apparatus, installing the second application into an information processing apparatus, and activating the second application.

10. The non-transitory computer-readable storage medium according to claim 1, wherein in a case where the first application of a version that is a target for the update by the update process is already downloaded in an information processing apparatus, the downloaded first application is activated without downloading the first application.

11. The non-transitory computer-readable storage medium according to claim 1, wherein in a case where the second application of a version that is a target for the execution by the execution process is already downloaded in an information processing apparatus, the downloaded second application is activated without downloading the second application.

12. The non-transitory computer-readable storage medium according to claim 1, wherein the information processing apparatus is a printer.

13. An information processing apparatus in which a program of a first application is installed, the information processing apparatus comprising:
one or more processors; and
one or more memories storing a program cooperating to:
perform an execution process for executing a second application different from the first application, the second application is linked with the first application; and
execute an update process for updating the first application in a case where a user instruction to perform the execution process is input.

14. An information processing method for an information processing apparatus in which a program of a first application is installed, the information processing method comprising:
performing an execution process for executing a second application different from the first application, the second application is linked with the first application; and
executing an update process for updating the first application in a case where a user instruction to perform the execution process is input.
